(19) United States
(12) Patent Application Publication
(10) Pub. No.: US 2013/0323380 A1
(43) Pub. Date: Dec. 5, 2013

(54) VEGETABLE PROTEIN CONCENTRATE

(71) Applicant: N.V. Desmet Ballestra Engineering S.A., Zaventem (BE)

(72) Inventors: Marc Kellens, Mechelen-Muizen (BE); Philippe Van Doosselaere, Uccle (BE)

(73) Assignee: N.V. Desmet Ballestra Engineering S.A., Zaventem (BE)

(21) Appl. No.: 13/963,075

(22) Filed: Aug. 9, 2013

Related U.S. Application Data
(63) Continuation of application No. 12/455,837, filed on Jun. 8, 2009.

(30) Foreign Application Priority Data
Jun. 20, 2008 (GB) GB0811380.5

(51) Int. Cl. A23J 1/14

(52) U.S. Cl. CPC A23J 1/144
USPC 426/430

(57) ABSTRACT

This invention relates to a process for preparing a vegetable protein concentrate from oleaginous vegetable material that comprises the steps of:
a) pre-treating the oleaginous vegetable material to open the cells;
b) extracting the pre-treated vegetable material in a first extractor with an apolar solvent, to produce a solvent-wet, defatted vegetable material;
c) contacting the defatted vegetable material with aqueous ethanol with an ethanol concentration of at least 80% by weight to produce a ethanol-wet, defatted vegetable material;
d) wetting the ethanol-wet, defatted vegetable material with aqueous ethanol;
e) extracting the vegetable material in an ultimate extractor to produce a solvent-wet proteinaceous material;
f) desolventising said solvent-wet proteinaceous material to produce a vegetable protein concentrate.

### CROSS-REFERENCE TO RELATED PATENT APPLICATIONS

This application is a continuation of U.S. patent application Ser. No. 12/455,837 filed Jun. 8, 2009, which in turn claims priority under 35 USC §119 of GB Application No. GB 0811380.5 filed Jun. 20, 2008.

### FIELD OF INVENTION

The invention relates to the production of vegetable protein concentrates from full fat or partially defatted oleaginous vegetable material.

### BACKGROUND OF THE INVENTION

Because of the relatively high protein content of oleaginous vegetable material such as but not limited to soya beans, such material is a highly suitable starting material for the production of vegetable based, proteinaceous food ingredients such as concentrates and isolates. More recently, soya concentrates are also being used as feed ingredient in aquaculture to alleviate a shortage of fish meal and/or to provide a cheaper and dioxin-free alternative. For nutritional reasons, this application demands a thorough removal of oligosaccharides from the vegetable material.

As mentioned in U.S. Pat. No. 4,219,470, the overall composition of soya beans on a dry basis is 40% protein, 29% carbohydrates and phosphatides, 21% triglyceride oil and 10% ash and fibres. Raising the protein content therefore entails the removal of other constituents. If the oil is removed by extraction, the protein content in the resulting meal containing 13% by weight moisture, is increased to 44% by weight and if the beans were to have been dehulled prior to their being extracted, a meal with a protein content of 48% by weight would have resulted. Producing protein concentrate by removing soluble carbohydrates (oligosaccharides such as saccharose, raffinose and stachyose) from the latter meal by extracting the meal with aqueous ethanol can raise its protein content further to some 70% by weight on a dry basis.

Raising it even further and producing isolates from defatted soya bean flakes, requires dissolving the protein and separating the dissolved protein from insoluble meal constituents such as the fibres comprised in the cell walls and subsequently precipitating the protein by lowering the pH of the protein solution and separating the precipitate from the carbohydrates that remain in solution. Isolates thus prepared can contain more than 90% protein on a dry basis. However, this process generates an aqueous effluent that demands intensive treatment before disposal. Therefore, isolates are expensive and for many applications, the somewhat lower protein content of the concentrates is fully acceptable. Accordingly, a number of processes to produce soya concentrates have been developed.

These processes differ in the order in which they extract the oil and the carbohydrates or sugars. The process disclosed in U.S. Pat. No. 3,971,856 starts with removing the sugars from dehulled soya beans with water, then dries the extracted beans, flakes them and extracts the oil with an apolar solvent. Other processes such as for instance disclosed in U.S. Pat. No. 3,268,503, use defatted soya flakes as starting material for the extraction of the sugars with a 50-70% aqueous solution of an ethanol. However, both these processes have the disadvantage that the intermediate product, i.e., the product that has already undergone one extraction and still has to be subjected to a second extraction process, has to be dried or desolventised.

To avoid this drying or desolventising, various solvent systems have been described. U.S. Pat. No. 3,714,210 discloses a two-phase liquid solvent: one phase consisting essentially of one or more lipophilic solvents and the other phase consisting essentially of a mixture of water and one or more water-miscible solvents. Oil and non-proteinaceous materials are simultaneously extracted providing a soya protein concentrate product that is light in colour and bland in taste. In this process, it is difficult to maintain flake integrity so that a proper percolation of the bed of material being extracted cannot always be assured.

Instead of a two-phase solvent system, a single-phase solvent system can also be used as disclosed by U.S. Pat. No. 4,219,470. The two solvents used are alcohol (ethanol) and water and by varying their ratio, the solvent mixture shows a preference for either extracting lipids or sugars. By first contacting full fat soya bean flakes with an aqueous ethanol stream containing 50-70% by weight of alcohol, the sugars contained in said flakes are extracted. Subsequently, the wet flakes are dried by contacting them with concentrated aqueous ethanol and when the ethanol is no longer diluted with water, it starts to dissolve and extract the lipids still present in the sugar-free flakes. This process also causes proteins to be extracted so that the concentrate yield is unacceptably low.

As disclosed by U.S. Pat. No. 3,734,901, it is also possible to extract the lipids first and then extract the sugars from the lipid-free extraction residue. To this end, the lipids are initially extracted from the soya bean flakes with a hydrocarbon/monohydric alcohol solvent followed by aqueous extraction of the water-soluble constituents. However, this process still incorporates the removal by evaporation of hexane from the extracted flakes that are substantially free from lipids before these flakes are exposed to aqueous solvent for the extraction of the water-soluble constituents.

### SUMMARY OF THE INVENTION

In one aspect of the invention, lipids and sugars can be extracted from oleaginous vegetable material while avoiding the need for complete intermediate desolventisation.

It has surprisingly been found that the intermediate desolventising step can be much simplified or even omitted in a process for preparing a vegetable protein concentrate from oleaginous vegetable material comprising triglyceride oil, sugars and protein, which comprises the steps of:
a) pre-treating the oleaginous vegetable material to open the cells;
b) extracting the pre-treated oleaginous vegetable material resulting from step (a) in a first extractor with an apolar solvent to produce a first miscella containing oil and solvent-wet, defatted vegetable material;
c) contacting said defatted vegetable material with aqueous ethanol with an ethanol concentration of at least 80% by weight to replace the apolar solvent at least partially with ethanol and produce a second miscella and ethanol-wet, defatted vegetable material;
d) wetting said ethanol-wet, defatted vegetable material with aqueous ethanol while transferring said material from said first extractor to a ultimate extractor;
e) extracting said vegetable material in said ultimate extractor with an aqueous ethanol stream containing 50 to 90% by weight of ethanol to produce a third miscella stream containing sugars and a solvent-wet proteinaceous material;
f) desolventising said solvent-wet proteinaceous material to produce a vegetable protein concentrate

Various aspects of the present invention are also realized by the vegetable concentrate produced by the above-disclosed process.

In accordance with one aspect of the invention, it is an advantage that contacting the defatted vegetable material with concentrated aqueous ethanol replaces the apolar solvent and thus avoids the need for complete desolventisation.

It is an advantage of certain exemplary embodiments of the process according to the invention that wetting the ethanol-wet, defatted vegetable material maintains its integrity and thus ensures efficient percolation in the subsequent extraction step e).

It is also an advantage of certain exemplary embodiments of the process according to the invention that the proteins present in the vegetable material keep their digestability when used as a feed ingredient.

It is an advantage of certain exemplary embodiments of the process according to the invention that the steam consumption is lower than prior art processes.

### BRIEF DESCRIPTION OF THE DRAWINGS

FIG. 1 shows a flow diagram of a particular embodiment of the process according to the invention; it also illustrates a number of optional features of this process.

### DETAILED DESCRIPTION OF EXEMPLARY EMBODIMENTS

The term miscella, as used in disclosing the present invention, means a solution of oil in a solvent such as resulting from a solvent extraction process.

The term protein concentrate, as used in disclosing the present invention, means a derivative of an oilseed extraction residue (meal) with an increased protein content.

The process according to the invention relates to the production of vegetable protein concentrates from oleaginous vegetable material in general and oilseeds comprising vegetable oil, vegetable protein and oligosaccharides in particular. It produces said vegetable protein concentrates by extracting the oil from said oleaginous vegetable material with an apolar solvent such as but not limited to hexane, and subsequently extracting the oligosaccharides from the defatted extraction residue with aqueous ethanol.

Because of its protein content and amino acid composition, soya beans constitute a preferred raw material for the process according to the invention. However, soya beans also contain oligosaccharides that include saccharose, raffinose and stachyose whereby the latter two contain P-galactosidic bonds. Humans lack the enzymes to hydrolyse these bonds and thus cannot digest these sugars. Accordingly, they are broken down microbially in the large intestine and this leads to flatulence. The absence of these oligosaccharides in a soya bean based proteinaceous product to be used for human food is therefore highly desirable. Similarly, concentrates to be used for fish feed command a higher price the lower their residual sugar content.

Soya beans also contain fibre components and although their presence in the proteinaceous product made by the process according to the invention may be quite acceptable for some applications, other applications such as fish feed profit from a low fibre content of the proteinaceous product. Since the soya bean hulls have a relatively high fibre content, the soya beans are preferably dehulled by any process known to those skilled in the art before being treated by the process according to the invention. The soya beans to be used in the process according to the invention may be the result of genetic modification. If this genetic modification has changed the amino acid composition of the soya been protein in line with specific requirements for the product of the invention, such soya beans are especially preferred.

The process of the invention is not limited to soya beans. Other beans such as but not limited to the winged bean (Psophocarpus tetragonolobus) that is being grown in increasing amounts in Asia also constitute suitable raw materials for the process according to the invention. Other oilseeds such as but not limited to canola (Brassica napus and B rapa) or sunflower seed (Helianthus annuus) can also serve a suitable raw materials. Again, these oilseeds are preferably dehulled before being treated by the process according to the invention i.e. prior to pre-treating the oleaginous vegetable material to open the cells. Yet another oleaginous vegetable material that can be profitably processed according to the invention is corn germ.

To facilitate extraction, in one exemplary embodiment, the first step a) of the process involves a pre-treatment of the oleaginous vegetable material to rupture the cell walls in this material. This pre-treatment may comprise a flaking treatment. In this treatment, the oilseeds are compressed between two cylindrical rollers and flattened into flakes. Before this treatment, the oilseeds may have been conditioned by a heat treatment to soften the material and thereby reduce the energy requirement of the actual flaking process. Because of the compression and shearing forces involved in this flaking process, almost all cells in the oil seed are opened by rupture of their walls. This opening of the cells greatly facilitates extracting the cell contents by avoiding the need to diffuse through cell walls. Beans are preferably cracked using corrugated cracking rolls before being flaked whereby this cracking operation can be part of a dehulling treatment. A typical flake thickness aimed for in the case of soya beans is 0.25 to 0.35 mm or preferably 0.28 to 0.32 mm

Another pre-treatment causing cell walls in the oleaginous vegetable material to be ruptured is screw pressing since this also entails strong compression and shearing forces. Screw pressing does not remove all oil from the oleaginous vegetable material so the resulting press cake still contains some oil and thereby constitutes a suitable material to be extracted in step b) of the process according to the invention. It can be extracted as such but preferably after having been pelleted since this treatment also causes further cell walls to be ruptured. In addition, the pellets have better percolation characteristics than the press cake. In yet another embodiment of step a) of the process according to the invention, an expander is used to pre-treat the oleaginous vegetable material.

In the next step of the process according to an exemplary embodiment of the invention, the pre-treated material is extracted with an apolar solvent such as but not limited to ‘hexane’, which is the name given to an industrial petroleum fraction consisting primarily of C₆ saturated hydrocarbons such as n-hexane, methylpentanes, methylcyclopentane, etc. The extraction is carried out in a first extractor, which is preferably of the percolating type using a moving belt since this type has the advantage of preserving the integrity of the flakes, but the process according to the invention is on no way limited to this type of extractor. In this type of extractor, the oilseed flakes and the extraction solvent move in opposite directions so that a counter-current extraction is realised.

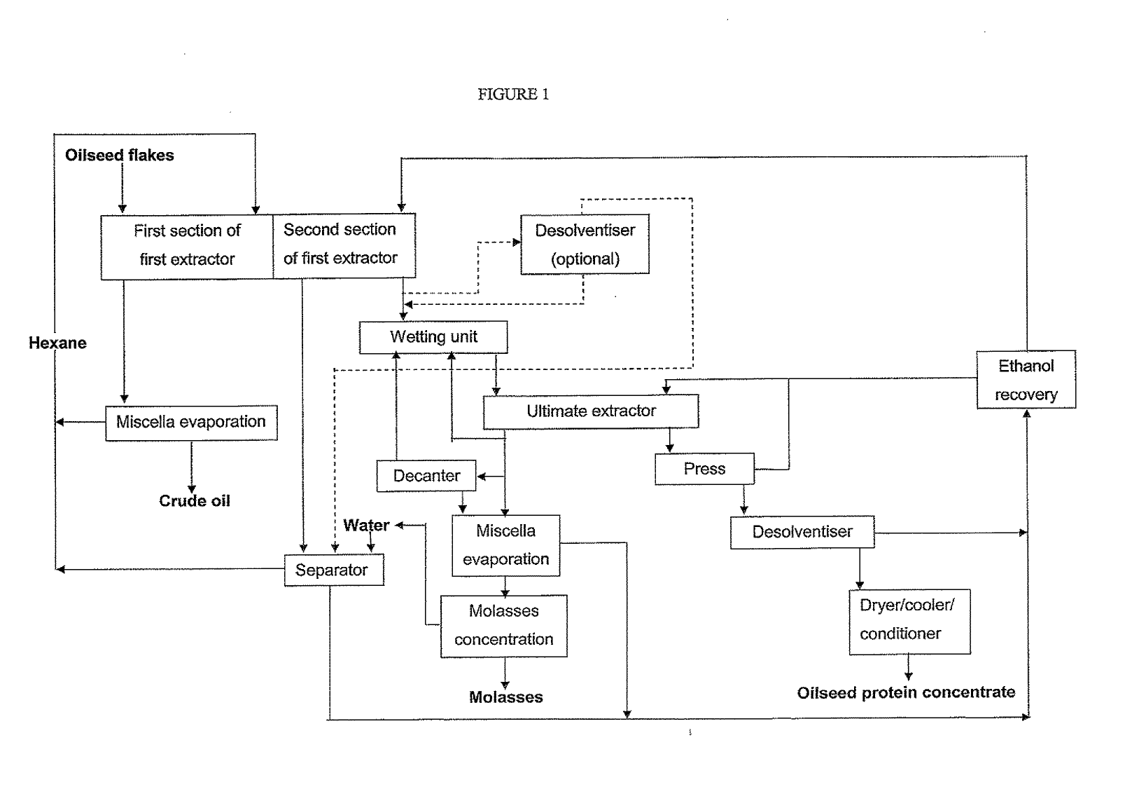

However, as illustrated in FIG. 1, the first extractor may be divided into two sections. The first section into which the pre-treated material resulting from step a) is introduced at one end and fresh hexane is introduced at the other end, ensures oil removal from said pre-treated material. Accordingly, a hexane-oil miscella leaves the first section at the end where the pre-treated material is introduced and a hexane-wet marc leaves the section at the other end to go into the second section. Standard process conditions can be adopted in the first section of said first extractor. Accordingly, a miscella strength of for instance 25-30% by weight of oil can be aimed for and an operating temperature just below the atmospheric boiling point of hexane (62° C.) is perfectly adequate. This way, a residual oil content of the defatted material of less than 1% by weight or preferably less than 0.5% by weight can be attained.

In said second section, ethanol of more than 80% strength by weight is fed at the end opposite to the end where the hexane-wet material is introduced and made to flow counter-currently to said material in step c) of the process according to the invention. The preferred strength of the aqueous ethanol used in step c) of the process according to the invention is about 95% by weight, this being the ethanol concentration in the atmospheric ethanol/water azeotrope. Using ethanol of this strength has also the advantage that it denatures the vegetable protein and makes it less soluble in the aqueous ethanol used in the extraction step e) without appreciably decreasing its digestibility. Accordingly, a second miscella consisting of a mixture of hexane and ethanol leaves the second section of the first extractor at the end where the hexane-wet, defatted material was introduced and ethanol-wet material leaves the second section at the other end.

In one embodiment of the process according to the invention, the ethanol-wet material, the marc resulting from step c) is passed immediately to the wetting unit of step d). In another embodiment, the marc is at least partially desolventised by exposing it to diminished pressure in a type of desolventiser that allows operating at sub-atmospheric pressure. This causes the most volatile part of the solvent present in the marc to evaporate and thus diminishes or virtually eliminates the amount of hexane moving downstream. Ethanol and hexane form an azeotrope boiling at 58.7° C. at atmospheric pressure that contains 21% by weight of ethanol. Consequently, the condensate from the desolventiser is preferably combined with the ethanol stream to be sent to the separator where water is added and the resulting phases are separated. In FIG. 1, the flows involved in this latter embodiment have been drawn in dashed lines.

If the desolventiser comprises indirect heating, this may raise the temperature of the material being desolventised and thereby reduce the solubility in water of the proteins present in this material. This will increase the final product yield but on the other hand, care has to be taken not to affect critical final product properties such as protein digestibility. In yet another embodiment, the ethanol-wet marc is partially desolventised by mechanical means such as squeezing the layer of flakes on the moving belt. This partial desolventisation is therefore carried out at the end of the second section of the first extractor and the liquid squeezed out from the marc is combined with the ethanol stream to be sent to the separator where water is added to obtain a phase separation. During this desolventisation by squeezing, care has to be taken to maintain flake integrity.

In one exemplary embodiment in step d) of the process, the ethanol-wet, defatted material is wetted with aqueous ethanol. During this wetting treatment, said material absorbs an appreciable amount of this solvent and by relegating this wetting to a separate step and introducing wetted material into an ultimate extractor, proper percolation of this material is maintained. The actual wetting step of step d) can be executed in a number of ways but care should be taken to maintain the integrity of the defatted material as much as possible. A preferred way involves the use of a slowly rotating helical screw that combines mixing the ethanol-wet material with the wetting agent while transporting the material to the ultimate extractor e.g., from the first extractor to the ultimate extractor during which it is optionally heated. This screw should be proportioned in such a way that a minimum wetting time of 10 minutes is provided and that this time does not exceed 20 minutes. Using a helical screw also offers the possibility to heat the material being wetted and thus enables the ultimate extractor to be operated at a higher temperature than the first extractor. To this end, the housing surrounding said helical transport screw can be steam jacketed. Another way to raise the temperature of the material being extracted in the ultimate extractor is by heating the extraction solvent before this is being sprayed onto the material being extracted.

Carrying out the extraction of the pre-treated material with hexane and the subsequent replacement of the hexane by ethanol in the same, first extractor has the disadvantage that the solvent vapours may get mixed. Therefore, another embodiment of the process according to the invention entails the use of an intermediate extractor between the first extractor and the ultimate extractor. The hexane-wet marc is introduced into a first section of said intermediate extractor, where the hexane-wet marc is washed with ethanol with a strength of at least 80% and preferably about 95% by weight producing a second miscella. After the hexane removal, the ethanol-wet material is wetted while care should be taken to maintain the integrity of the material so as not to decrease its percolation characteristics. After the wetting treatment of step d), the sugars are extracted using more dilute aqueous ethanol. This can be done in a second section of the intermediate extractor but to avoid mixing different solvent vapours, it is preferably carried out in a separate, ultimate extractor.

As illustrated in FIG. 1, the solvent used to wet the ethanol-wet flakes is part of the third miscella originating from the ultimate extractor. In this particular embodiment, its composition will reflect the extraction process of step e). It will be a dilute aqueous ethanol with some oligosaccharides dissolved and its use as wetting agent saves on solvent purification. However, the process according to the invention is not limited to this particular embodiment. In another embodiment, the entire amount of the third miscella leaving the ultimate extractor is fed to a decanter thus yielding a clear supernatant and a solids stream (sludge) which is used in the wetting treatment of step d); if necessary, this solids stream can be diluted with miscella leaving the ultimate extractor. The use of a decanter as illustrated in FIG. 1 has the advantage that fines are recycled to the extractor and that the miscella treatment system is largely protected from fouling.

The amount and composition of the aqueous ethanol used to extract sugars from the defatted and wetted flakes in step e) depend on final product requirements. In general, it has been found that when the ethanol contains more water, it is more effective in extracting sugars. Accordingly, less extraction solvent is required and a more concentrated miscella will result. However, a less concentrated aqueous ethanol is also a better solvent for proteins and its use therefore causes the protein content of the final protein concentrate to be reduced. This reduction can to some extent be limited by adjusting the pH of the aqueous ethanol to the isoelectric point of the protein. For soya protein, this means lowering the pH to around 4.5. Consequently, a protein content in excess of 70% by weight requires an ethanol content of the extraction solvent in excess of 60 or even 70% by weight and may this lead to a third miscella containing only 6% of sugars or even less. In a similar vein, residual sugars in the protein concentrate affect its protein content and especially the amount of solvent to be used and thus its sugar content.

Finally, the marc leaving the ultimate extractor is desolventised in step f) of the process according to the invention. Since the latent heat of evaporation of the solvent used in step e) of the process is high (40 kJ/mol or 2.2 kJ per gram for water and 38 kJ/mol or 0.83 kJ per gram for ethanol as opposed to 29 kJ/mol or only 0.34 kJ per g for hexane), it is advantageous to minimise the amount of solvent that has to be evaporated. Since at this stage of the process, the integrity of the flakes is no longer critical, a standard press is used in a preferred embodiment to squeeze out as much as possible of the solvent contained in the solvent-wet flakes leaving the ultimate extractor, provided this press has been constructed in an explosion proof manner As shown in FIG. 1, the solvent mixture leaving the press, having almost the same composition as the extraction solvent fed to the ultimate extractor can profitably be returned to said extractor.

The press cake resulting from the press used to recuperate some solvent can then be fully desolventised in a standard desolventiser by supplying indirect heat, direct heat by means of steam, or both. During desolventisation, time and temperature are critical parameters with respect to protein denaturation, the magnitude of which is governed by the final product specification. As illustrated in FIG. 1, the desolventised product may be dried and cooled before being further converted into the final product for sale. This conditioning may comprise, grinding, classification, blending and packaging.

In accordance with one exemplary embodiment of the invention, three miscella streams are generated. There is the apolar miscella stream containing the oil that has been extracted from the flakes in the first section of the first extractor. This miscella stream is evaporated to separate oil and solvent just like the miscella originating in a standard oil seed extraction plant. Therefore, if the plant operating the process according to the invention is part of an oil-milling complex, it may be advantageous to have this miscella evaporated in the multi-stage evaporator that forms part of the solvent extraction unit of this oil mill

The second miscella originating from the process according to the invention arises in the second section of the first extractor or in the intermediate extractor. It consists basically of a mixture of an apolar solvent like hexane and ethanol and some water although the defatted hexane-wet flakes may well absorb some water when brought into contact with aqueous ethanol even when the water content of the ethanol is close the azeotropic condition. According to the hexane/ethanol/water phase diagram shown in U.S. Pat. No. 3,998,800, it follows that addition of further water to this solvent mixture will soon lead the formation of two phases: a hexane phase containing only a small amount of ethanol and an aqueous ethanol phase. So in a preferred embodiment of the process according to the invention, water is added to the said second miscella stream and after settling, the upper hexane layer is sent to the first section of the first extractor as an oil extraction solvent, whereas the lower, aqueous ethanol layer is sent to the ultimate extractor as a sugar extraction solvent.

This sugar extraction leads to a third miscella comprising ethanol, water and sugars; it may also contain some protein and other oleaginous seed components that are soluble in aqueous ethanol. As shown in FIG. 1, the sugars are first of all recovered as molasses by evaporating the ethanolic solvent; then they are isolated as a dry solid by evaporating the water contained in the molasses. However, this is only a particular embodiment of the process according to the invention and the invention is in no way limited to said embodiment. By choosing appropriate evaporation conditions, ethanol of different strengths can be recovered in the different evaporation stages and those skilled in the art are fully familiar with optimising the solvent recovery in function of the particular process requirements. Accordingly, FIG. 1 only indicates an ethanol recovery section without providing any detail about the water contents of the various ethanol streams.

Another exemplary embodiment of the process according to the invention that has not been included in FIG. 1 comprises the use of an apolar solvent such as hexane in the desolventisation step f). By providing the ultimate extractor with a second section and feeding this second section not only with the ethanol-wet proteinaceous material but also with said apolar solvent, at least partial replacement (displacement) of the ethanol by the apolar solvent can be achieved followed by an evaporative removal of the solvents present. If the temperature of the material in the first part of the ultimate extractor is above the hexane boiling point of 62° C., it must be lowered by spraying it with cold aqueous alcohol at the end of the first section of the ultimate extractor before spraying it with hexane in the second section of said extractor. To this end, a heat exchanger has to be incorporated in the aqueous alcohol distributing system. The ensuing ethanol/hexane/water mixture can then be sent to the separator shown in FIG. 1 and the solvent wet proteinaceous material can be desolventised while requiring much less energy than when the only solvents present were ethanol and water. In this embodiment, the desolventiser condensate comprising mainly said apolar solvent and ethanol should also be treated in the separator shown in FIG. 1.

Similarly, in yet another embodiment of the process according to the invention, the ethanol-wet proteinaceous material is ‘dried’ by washing it with aqueous ethanol with an ethanol concentration of at least 80% by weight and preferably about 95% by weight followed by an evaporative removal of any solvents present. This leads to a marc with a low water content which requires less energy in desolventisation and a solvent mixture that can be used to extract sugars from the wetted material resulting from step d) of the process according to the invention. Other embodiments along the above lines will suggest themselves to those skilled in the art; they form part of the process according to the invention.

### EXAMPLES

In the laboratory experiments illustrating the process according to the invention, soya bean were flaked and the resulting flakes were extracted in a Soxhlet with hexane for 1.5 hours. The resulting defatted flakes were then transferred to a glass column (height 30 cm and 5 cm diameter) fitted with a filter and a valve at the lower end and provided with a jacket connected to an oil bath. A recirculation pump collects the solvent below the filter and reintroduces it at the top of the column to simulate the percolation of an industrial extractor. The rate of percolation was measured by determining the length of time the solvent level needed to descend from one marking on the column to a lower one.

After wetting the defatted flakes with some hexane to compensate for any hexane lost by evaporation and a drainage time of a few minutes, the hexane-wet flakes were treated with ethanol with varying water contents. After the hexane-ethanol mixture had been allowed to drain, the ethanol-wet flakes were removed from the glass column, placed in a glass beaker and contacted with the more dilute ethanol to be used for the sugar extraction causing them to swell. After swelling, the flakes were transferred back to the column and extracted with dilute ethanol. This extraction comprised eight washes with diluted ethanol, each wash lasting 20 minutes plus 2 minutes draining time. After the last wash, the extracted flakes were desolventised for 120 minutes at 85° C. and then overnight at room temperature.

Extraction solvent samples were taken to determine the loss of sugars and the protein yield was determined by analysis of the starting material and the final sample; nitrogen content was determined by use of the Kjeldahl method and protein content was calculated according to N×6.25.

### Example 1

In this example, the effect of the water content of the aqueous ethanol used to extract the sugars from the ethanol-wet, defatted flakes is investigated. Soya bean flakes were extracted with hexane, the hexane-wet defatted flakes were washed with the ethanol-water azeotrope for a contact period of 5 minutes and then extracted with aqueous ethanol at a temperature of 62.5° C.

TABLE 1

| | Experiment number | | | | |
|---|---|---|---|---|---|
| | 36 | 11 | 30 | 37 | 34 |
| Ethanol/water ratio | 60/40 | 70/30 | 70/30 | 70/30 | 80/20 |
| Percolation rate (m³/m² · h) | 24 | 15 | 11 | 19 | 29 |
| Extraction yield (%) | 28.7 | 24.7 | 24.4 | 25.0 | 23.5 |
| Protein content (% on dry matter) | 71.4 | 68.9 | 73.8 | 71.2 | 72.0 |
| Protein yield (%) | 89.3 | 88.7 | 93.7 | 90.0 | 95.1 |

The experiment using the 70/30 ethanol/water mixture was carried out in triplicate. Table 1 shows that the reproducibility of the experiment is not perfect and the likely cause is the fact that raw material from different batches has been used. On the other hand, Table 1 shows clearly that increasing the ethanol content of the extraction solvent mixture can lead to an increased protein yield because of the reduced protein solubility. This high ethanol content also leads to a high rate of percolation and may cause the extraction yield to decrease somewhat since a low water content may well decrease the solubility of the sugars being extracted.

### Example 2

In this example, the effect of the contact period during which the hexane-wet, defatted flakes are wetted with ethanol is studied at several extraction temperatures. The ethanol/water ratio was 70/30 in all experiments

TABLE 2

| Experiment number | 14 | 12 | 13 | 10 | 30 | 28 |
|---|---|---|---|---|---|---|
| Extraction temperature (° C.) | 55 | | | 62.5 | | |
| Contact period (min) | 0 | 5 | 10 | 0 | 5 | 10 |
| Percolation rate (m³/m² · h) | 19 | 20 | 23 | 9 | 11 | 32 |
| Extraction yield (%) | 25.3 | 26.7 | 27.9 | 24.4 | 24.4 | 26.0 |
| Protein content (%) | 70.3 | 72.7 | 68.1 | 68.5 | 73.8 | 74.4 |
| Protein yield (%) | 98.9 | 91.7 | 84.6 | 87.7 | 93.7 | 94.9 |

From Table 2 it is clear that the percolation rate increases when the contact period is increased but other effects seem to be less equivocal and look like being temperature dependent but the variability of the starting material may also have played a role.

What is claimed is:

1. A process for preparing a vegetable protein concentrate from oleaginous vegetable material comprising triglyceride oil, sugars and protein, said process comprising the steps of:
a) pre-treating the oleaginous vegetable material to open the cells;
b) extracting the pre-treated oleaginous vegetable material resulting from step a) in a first percolation extractor with an apolar solvent to produce a i) first miscella containing oil and ii) solvent-wet, defatted vegetable material;
c) contacting said solvent-wet defatted vegetable material ii) with a first ethanol composition comprising aqueous ethanol with an ethanol concentration of at least 80% by weight and thereby replacing the apolar solvent at least partially with ethanol and producing a second miscella and ethanol-wet, defatted vegetable material;
d) wetting said ethanol-wet, defatted vegetable material with a second ethanol composition comprising aqueous ethanol while transferring said ethanol-wet defatted vegetable material from said first extractor to an ultimate percolation extractor;
e) extracting said ethanol-wet defatted vegetable material in said ultimate percolation extractor with an aqueous ethanol stream containing 50 to 90% by weight of ethanol thereby producing a third miscella stream containing sugars and a solvent-wet proteinaceous material;
0 desolventising said solvent-wet proteinaceous material to produce a vegetable protein concentrate.

2. The process according to claim 1 in which the oleaginous vegetable material comprises oilseeds that have been at least partially dehulled before being pre-treated in step a).

3. The process according to claim 1 in which the pre-treated of step a) is carried out by flaking the vegetable material.

4. The process according to claim 1 in which the pre-treatment of step a) is carried out by screw pressing the vegetable material.

5. The process according to claim 4 in which the vegetable material having been screw pressed is subsequently pelleted before being extracted in step b).

6. The process according to claim 1 in which the first ethanol composition used to contact the defatted vegetable material in step c) has the composition of the ethanol/water azeotrope.

7. The process according to claim 1 in which the ethanol-wet, defatted vegetable material resulting from step c) is at least partially desolventised.

8. The process according to claim 1 in which the ethanol-wet, defatted vegetable material is at least partially desolventised by exposing them to a sub-atmospheric pressure.

9. The process according to claim 1 in which the ethanol-wet, defatted vegetable material is at least partially desolventised by mechanical means.

10. The process according to claim 1 in which the ethanol-wet, defatted vegetable material is wetted in step d) with part of the third miscella emerging from the ultimate extractor.

11. The process according to claim 1 in which the third miscella emerging from the ultimate extractor is fed to a decanter thus yielding a clear supernatant and a sludge whereby this sludge is used to wet the ethanol-wet, defatted vegetable material in step d).

12. The process according to claim 1 in which the ethanol-wet, defatted vegetable material being wetted in step d) is heated while being transported.

13. The process according to claim 1 in which a press is used to reduce the solvent content in the solvent-wet proteinaceous material resulting from step e) and wherein the resulting press cake is subsequently desolventised.

14. The process according to claim 1 in which the desolventisation of step f) comprises an at least partial displacement of the solvent present in the solvent-wet proteinaceous material resulting from step e) by an apolar solvent followed by an evaporative removal of any solvents present.

15. The process according to claim 1 in which the desolventisation of step f) comprises an at least partial displacement of the solvent present in the solvent-wet proteinaceous material resulting from step e) by aqueous ethanol with an ethanol concentration of at least 80% by weight followed by an evaporative removal of any solvents present.

16. Vegetable protein concentrate produced by a process for preparing a vegetable protein concentrate from oleaginous vegetable material comprising triglyceride oil, sugars and protein, said process comprising the steps of:
a) pre-treating the oleaginous vegetable material to open the cells;
b) extracting the pre-treated oleaginous vegetable material resulting from step (a) in a first percolation extractor with an apolar solvent to produce a i) first miscella containing oil and ii) solvent-wet, defatted vegetable material;
c) contacting said solvent-wet defatted vegetable material ii) with a first ethanol composition comprising aqueous ethanol with an ethanol concentration of at least 80% by weight to replace the apolar solvent at least partially with ethanol and produce a second miscella and ethanol-wet, defatted vegetable material;
d) wetting said ethanol-wet, defatted vegetable material with a second ethanol composition comprising aqueous ethanol while transferring said ethanol-wet defatted vegetable material from said first extractor to an ultimate percolation extractor;
e) extracting said ethanol-wet defatted vegetable material in said ultimate extractor with an aqueous ethanol stream containing 50 to 90% by weight of ethanol to produce a third miscella stream containing sugars and a solvent-wet proteinaceous material;
f) desolventising said solvent-wet proteinaceous material to produce a vegetable protein concentrate.

17. A process as recited in claim 1 wherein said apolar solvent is hexane.

18. A process as recited in claim 16 wherein said apolar solvent is hexane.
